(19) United States
(12) Patent Application Publication
(10) Pub. No.: US 2014/0380153 A1
(43) Pub. Date: Dec. 25, 2014

(54) METHOD FOR DIVIDING PAGES AND ELECTRONIC DISPLAY DEVICE

(71) Applicant: Acer Incorporated, New Taipei City (TW)

(72) Inventors: Jhao-Dong Chiu, New Taipei City (TW); Ting-Feng Chou, New Taipei City (TW)

(73) Assignee: Acer Incorporated, New Taipei City (TW)

(21) Appl. No.: 14/028,530

(22) Filed: Sep. 16, 2013

(30) Foreign Application Priority Data
Jun. 19, 2013 (TW) 102121755

(51) Int. Cl. G06F 17/21

(52) U.S. Cl. CPC G06F 17/217
USPC 715/251

(57) ABSTRACT

A method for dividing pages and an electronic display device are provided. The method for dividing pages includes the following steps. An edit page is started on the display screen, and a length of an editable area is increased in the edit page when the edit page is pulled down. The edit page receives a paging operation to generate at least one page break in at least one position of the edit page. When the at least one page break is generated, the edit page is divided into at least two separate pages according to the at least one page break, and the separate pages are respectively saved as different files. The method for dividing pages is more convenient and user-friendly for the user operating a data editing operation of the electronic display device.

### CROSS-REFERENCE TO RELATED APPLICATION

This application claims the priority benefit of Taiwan application serial no. 102121755, filed on Jun. 19, 2013. The entirety of the above-mentioned patent application is hereby incorporated by reference herein and made a part of this specification.

### BACKGROUND

1. Field of the Invention

The present invention is directed to a method for dividing pages and more particularly, to a method for dividing an edit page into separate pages with different sizes and an electronic display device applicable for the method.

2. Description of Related Art

At present, applications to handheld smart electronic apparatuses have become more and more diversified. In the meantime, these types of electronic apparatuses are available for being carried with users anywhere and thus, developed or combined with various functions for daily life. For example, a handheld smart electronic apparatus may function as a notebook or a notepad, and in these note applications, an edit page having a single area is displayed for the user to perform applications, such as copy/paste figures or text edition.

Because an edit area or size of the edit page may probably be insufficient for the applications of the user, an “add page” function is therefore produced. When using such “add page” function, a page with a fixed size is commonly added in the beginning or the page is pulled down/extended according to editing needs or editing situations of the user to correspondingly increase the number of pages for the user's sequential recording. However, this manner often leads to an overly large size of file content of the edit page and the difficulty in classifying or separately storing the edited content of different blocks after the user completes the data editing operation. As a result, the usage of this manner is neither convenient nor user-friendly due to the lack of operational flexibility.

### SUMMARY

The present invention is directed to a method for dividing pages and an electronic display device using the method, by which a user may perform a dynamic paging operation on data to be edited according to the user's usage needs during the editing process, so as to enhance the convenience for the user while performing the data classifying, data storing or sequential data editing operation.

The present invention is directed to a method for dividing pages, applicable for an electronic display device. The method includes steps as follows. An edit page is started on a display screen, wherein a length of an editable area in the edit page is increased when the edit page is pulled down. A paging operation is received to generate at least one page break in at least one position of the edit page. And, when the at least one page break is generated, the edit page is divided into at least two separate pages according to the at least one page break, wherein the separate pages are respectively saved as different files.

The present invention is directed to an electronic display device, including a display screen, a processor and a memory unit. The display screen is configured to start an edit page on a display screen, wherein a length of an editable area is increased in the edit page when the edit page is pulled down. The processor is coupled to the display screen and configured to receive a paging operation to generate at least one page break in at least one position of the edit page and divide the edit page into at least two separate pages according to the at least one page break. The memory unit is coupled to the processor and configured to respectively save the separate pages as different files.

Based on the above, in the method for dividing pages and the electronic display device provided by the present invention, the edit page may be automatically divided into two or more separate pages according to an editing gesture or a paging operation of the user. Thus, the separate pages are respectively saved as different files, such that the user may easily distinguish objects and files when organizing the edit page. In other words, in light of the embodiments of the present invention, the user may perform a dynamic paging operation according depending on usage needs during an editing process so as to enhance the convenience for the user while performing the data classifying, data storing or sequential data editing operation.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a flowchart illustrating a method for dividing pages according to an embodiment of the present invention.

FIG. 2 is a schematic diagram of a method for dividing pages according to a first embodiment of the present invention.

FIG. 3 is a schematic diagram of a method for dividing pages according to a second embodiment of the present invention.

FIG. 4 is a schematic diagram of a method for dividing pages according to a third embodiment of the present invention.

FIG. 5A is a schematic diagram of a method for dividing pages according to a fourth embodiment of the present invention.

FIG. 5B is a schematic diagram of a method for dividing pages according to a fifth embodiment of the present invention.

FIG. 6 is a schematic block diagram illustrating an electronic display device according to the present invention.

### DESCRIPTION OF EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

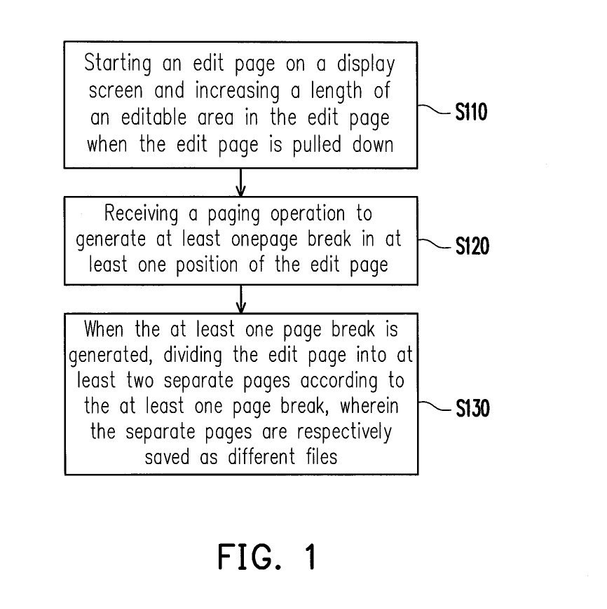

FIG. 1 is a flowchart illustrating a method for dividing pages according to an embodiment of the present invention. In the present embodiment, the method for dividing pages is applicable to an electronic display device. The electronic display device is provided with a touch input function and may be, for example, a smart phone, a tablet PC, and so on, but the present invention is not limited thereto.

Each step of the method for dividing pages is roughly described herein. Referring to FIG. 1, first, in step S110, the electronic display device starts an edit page on a display screen of the electronic display device. When the edit page is pulled down, a length of an editable area is increased in the edit page. Then, in step S120, a paging operation is received to generate at least one page break in at least one position of the edit page. Finally, in step S130, when the at least one page break is generated, the edit page is divided into at least two separate pages according to the at least one page break, wherein the separate pages are respectively saved as different files.

In order to describe the method for dividing pages proposed by the present invention in detail, different embodiments are illustrated with reference to the accompanying drawings for description.

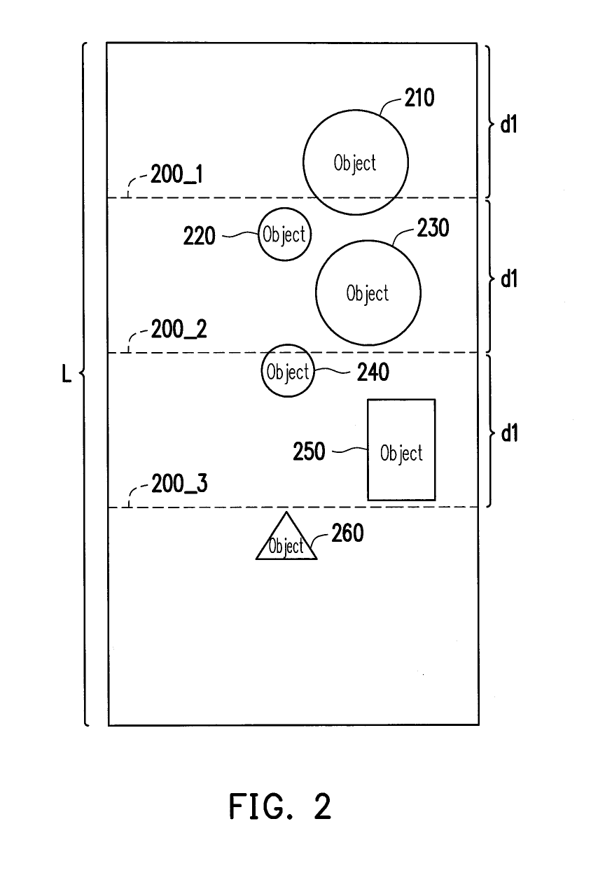

FIG. 2 is a schematic diagram of a method for dividing pages according to a first embodiment of the present invention. In the present embodiment, a user may pull down an edit page 200 to increase a length L of editable area in the edit page 200. For example, in the beginning, an edit page 200 with a fixed size and area is provided on an electronic display device of the present embodiment. If the user needs more edit pages 200 to continue to record data using fingers, a virtual keyboard or a stylus pen, the electronic display device allows the user to scroll down the edit page 200 to increase a length L of the edit page 200 to increase the area of the edit page 200.

The user may record a plurality of themes or data upon various needs in the same edit page 200, and this leads the user desiring to divide objects in the edit page 200 into two or more separate pages, such that each of the separate pages has its own objects. By doing so, the user is provided with a more intuitive and convenient operation mode when searching for data in the edit pages or classifying the data.

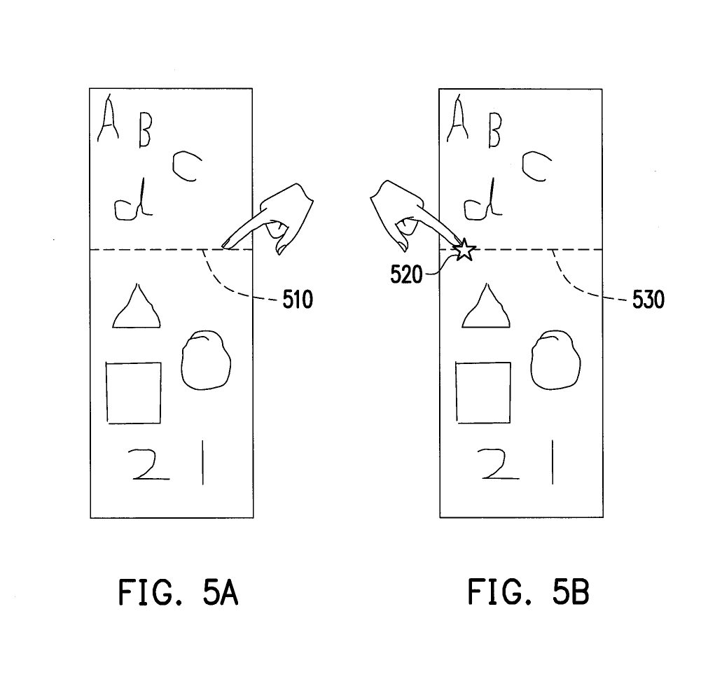

In the present embodiment, one of the edit pages 200 may be divided into different separate pages according to a predetermined length for being saved as different files or a so-called “page dividing” operation, as illustrated in FIG. 2. In another embodiment of the present invention, the “page dividing” operation may be performed according to a paging gesture performed by the user in the display screen, which will be described later with reference to FIG. 5A and FIG. 5B.

Continuously referring to FIG. 2, in the edit page 200 provided on the electronic display device in the beginning, a plurality page breaks is respectively generated in different positions according to a predetermined length value d1, and corresponding horizontal dividing lines 200_1, 200_2 and 200_3 are generated in the positions of the page breaks. By doing so, the length L in the editable area of the edit page 200 is divided into a plurality of segments having the same length, such that the edit page 200 are divided into a plurality of separate pages. In order to be clean and simple, only three horizontal dividing lines 200_1, 200_2 and 200_3 are illustrated in FIG. 2 for representation, but the present invention is not limited thereto.

It is to be noticed that in the present embodiment, the electronic display device further determines whether each of the horizontal dividing lines 200_1, 200_2 and 200_3 goes through one of objects 210, 220, 230, 240, 250 and 260 in the edit page 200.

Taking the horizontal dividing line 200_3 illustrated in FIG. 2 for example, the horizontal dividing line 200_3 does not go through the objects 250 and 260 in the edit page 200, and thus, the electronic display device may divides the edit page 200 into two separate pages according to the horizontal dividing line 200_3. However, taking the horizontal dividing line 200_1 illustrated in FIG. 2 for example, the horizontal dividing line 200_1 does not go through the object 220 in the edit page 200, but goes through the lower edge of the object 210 in the edit page 200, as shown in FIG. 2. Thus, the electronic display device needs a further determination method to bypass the object 210 and divide the edit page 200 into different separate pages.

On the other hand, it is to be mentioned that the “objects” (i.e., the objects 210, 220, 230, 240, 250 and 260 in the edit page 200 which are described in the present embodiment are icons or text generated when the user performs operations by fingers or the stylus pen, such as copy/paste of an image or text edition, on the edit page 200. Taking FIG. 2 for example, the objects 210, 220, 230, 240, 250 and 260 are respectively simple geometric shapes disposed on different positions in the edit page 200, but the present invention is not limited thereto.

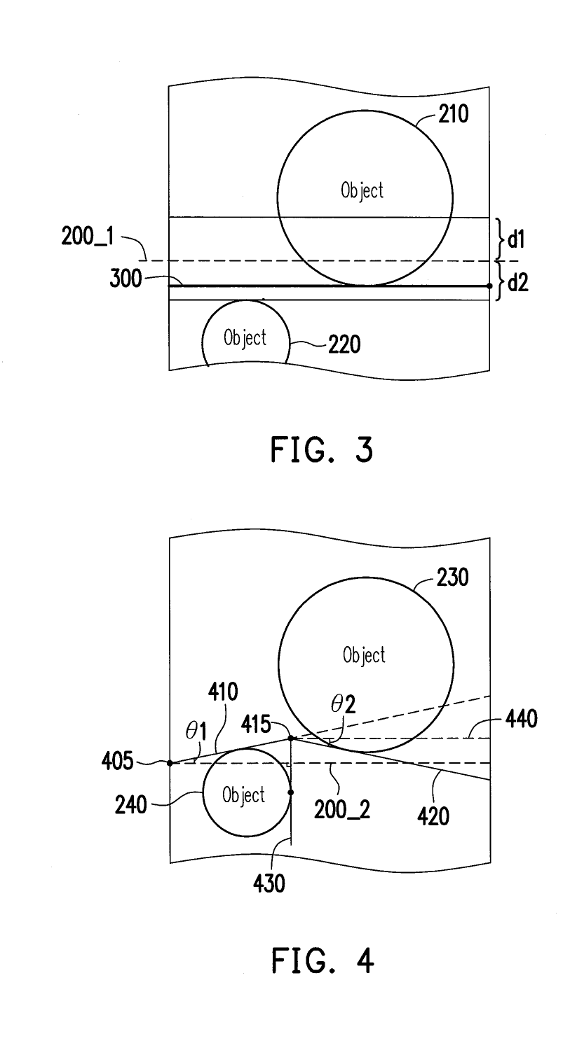

FIG. 3 is a schematic diagram of a method for dividing pages according to a second embodiment of the present invention. Referring to FIG. 2 and FIG. 3, in the present embodiment, the horizontal dividing line 200_1 illustrated in FIG. 2 is served as an example, that is, another implementation aspect of the method for dividing pages after the horizontal dividing line 200_1 goes through the object 210 in the edit page 200 as described in the first embodiment.

When the horizontal dividing line 200_1 goes through the object 210 in the edit page 200, the electronic display device first sets a predetermined horizontal range d2 neighboring with the horizontal dividing line 200_1, as illustrated in FIG. 3 and then, determines whether each horizontal line within the predetermined horizontal range d2 goes through the objects in the edit page 200. For example, the electronic display device performs the determination operation by scanning in the predetermined horizontal range d2 in a sequence, such as from up to down or from inside to outside. Finally, if the electronic display device determines that a specific horizontal line 300 is present within the predetermined horizontal range d2 and does not goes through any object (e.g. the object 210 and the object 220 in the illustrated example) in the edit page 200, the electronic display device divides the edit page 200 into different separate pages according to the specific horizontal line 300.

However, if the electronic display device determines that all of the horizontal lines within the predetermined horizontal range d2 do not conform to the condition not going through the object 210 and the object 220 in the edit page 200, the electronic display device may adopt a method for dividing pages (which will be described later) of a third embodiment illustrated in FIG. 4 to divide the edit page 200 into different separate pages.

FIG. 4 is a schematic diagram of a method for dividing pages according to a third embodiment of the present invention. Referring to FIG. 4 together with FIG. 2, in the present embodiment, the horizontal dividing line 200_2 illustrated in FIG. 2 is served as an example, that is, another implementation aspect of the method for dividing pages after the horizontal dividing line 200_2 goes through the object 240 in the edit page 200 as described in the first embodiment.

When the horizontal dividing line 200_2 goes through the object 240 in the edit page 200, on the horizontal dividing line 200_2, the electronic display device first sets a starting node 405 and an angle θ1 with respect to the horizontal dividing line 200_2 to generate a first diagonal 410 bypassing the object 240 in the edit page 200, wherein the angle θ1 is within a predetermined angle range θ defined by users applied the present embodiment. Then, when the first diagonal 410 bypasses the object 240 nearest to the starting node 405 in the edit page 200, the electronic display device keeps adjusting the angle θ1 in the predetermined angle range θ and stops adjusting the angle θ1 of first diagonal 410 with respect to the horizontal dividing line 200_2 until the first diagonal 410 does not goes through the objects nearest to the starting node 405 in the edit page 200 and reaches another end of the edit page 200.

For instance, if it is assumed that the predetermined angle range θ is 30°, and when the horizontal dividing line 200_2 goes through an upper edge of the object 240 in the edit page 200, the electronic display device sets a starting node 405 and an angle θ1 with respect to the horizontal dividing line 200_2 on the horizontal dividing line 200_2 to generate a first diagonal 410, wherein the angle θ1 is within a predetermined angle range 30°. When the first diagonal 410 goes through the object 240 nearest to the starting node 405 in the edit page 200, the electronic display device keeps adjusting the angle θ1 with respect to the horizontal dividing line 200_2 until the angle θ1 is, for example, 20° where the first diagonal 410 no longer goes through the object 240 in the edit page 200 and reaches another end of the edit page 200, that is, the angle θ1 for stopping the first diagonal 410 with respect to the horizontal dividing line 200_2 is 20°.

However, if the first diagonal 410 still goes through the object 230 in the edit page 200 even after the first diagonal 410 with respect to the angle θ1 bypasses the object 240 in the edit page 200, as illustrated in FIG. 4, at this time, based on the object 240 that is adjacent to the horizontal starting node 405 in the edit page 200, a node formed by intersecting a vertical boundary 430 of the object 240 that is the furthest form the starting node 405 and the first diagonal 410 is served as a terminal node 415 (or referred to as a turning point), and a second diagonal 420 is generated by using the terminal node 415 as another starting node.

Then, a horizontal line 440 is generated from the another starting node (i.e., the terminal node 415), and a second diagonal 420 having an angle θ2 with respect to the horizontal line 440 is generated from the starting node (i.e., the terminal node 415) set on the horizontal dividing line 200_2 to bypass the object 230 nearest to the starting node 415 in the edit page 200, wherein the angle θ2 is within the predetermined angle range θ. Then, when the second diagonal 420 goes through the object 230 in the edit page 200, the electronic display device keeps adjusting the angle θ2 in the predetermined angle range θ until the second diagonal 420 does not go through the object 230 in the edit page 200 and reaches another end of the edit page 200. At last, since a connection of both the first diagonal 410 and the second diagonal 420 does not go through the objects 230 and 240 in the edit page 200, the electronic display device then can divide the edit page 200 into different separate pages using the connection line of the first diagonal 410 and the second diagonal 420.

FIG. 5A is a schematic diagram of a method for dividing pages according to a fourth embodiment of the present invention. In the present embodiment, the electronic display device performs the paging operation according to a paging gesture made by the user on the display screen and divides the edit page 200 into at least two separate pages according to a moving path of the paging gesture with respect to the edit page 200. Taking FIG. 5A for example, a dividing line 510 is generated based on a paging gesture of the user. In the present embodiment, the user may generate any dividing straight or curved line by making the paging gesture on the electronic display device, and the present invention is not limited thereto.

FIG. 5B is a schematic diagram of a method for dividing pages according to a fifth embodiment of the present invention. The present embodiment is different from the embodiment illustrated in FIG. 5A in that the user may mark a page break 520 in the edit page 200 and use the page break 520 to generate a horizontal dividing line 530 served as a basis for dividing the edit page illustrated in FIG. 5B. In the present embodiment, even though the page break 520 is depicted as a stellate shape, the page break may be any form of geometric figure, icon or numeral or only an internal code stored in a system which is not shown in the display screen, and the present invention is not limited thereto.

On the other hand, the electronic display device may obtain an outline of each object in the edit page 200 by utilizing an object boundary detection mechanism. Thereby, the electronic display device may divide the edit page 200 into different separate pages by using a position of the page break as a starting node and along a connection line going through an upper or a lower edge of each object in the edit page 200.

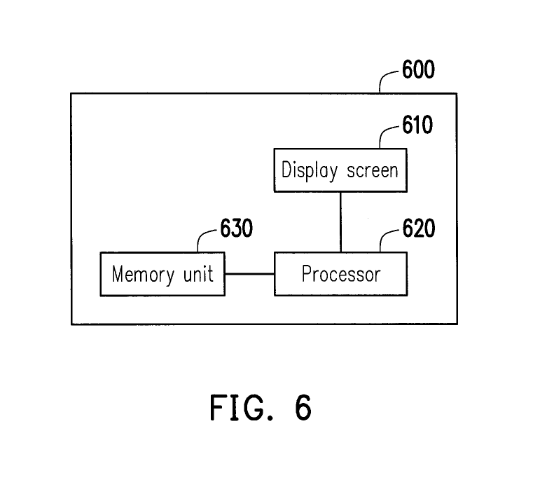

FIG. 6 is a schematic block diagram illustrating an electronic display device according to the present invention. Referring to FIG. 6 together with FIG. 1, an electronic display device 600 includes a display screen 610, a processor 620 and a memory unit 630. The display screen 610 is configured to display a started edit page, wherein a length of an editable area is increased in the edit page 200 when the edit page 200 is pulled down (i.e., step S110). The processor 620 is coupled to the display screen 610 and configured to receive a paging operation of a user to generate at least one page break in at least one position of the edit page and divide the edit page into at least two separate pages according to the at least one page break (i.e., step S120). The memory unit 630 is coupled to the processor 620 and configured to respectively save the separate pages as different files (i.e., step S130).

In the present embodiment, the display screen 610 is served as an input interface and a display interface of the electronic display device 600 and may be any type of touch screen, such as a resistive touch screen, a capacitive touch screen, an optical touch screen, an acoustic wave touch screen, an electromagnetic touch screen and so on, but the present invention is not limited thereto.

On the other hand, in the present embodiment, the memory unit 630 may be any type of storage medium having storage spaces, such as a conventional hard driver disk (HDD), a solid state disk (SSD), each type of volatile or non-volatile memory, but the present invention is not limited thereto. Moreover, the aforementioned storage medium may also be a network storage space (which is also referred to as a cloud storage space) on Internet, such as a DropBox, a SkyDrive and so on, but the present invention is not limited thereto.

To sum up, the method for dividing pages and the corresponding electronic display device provided by the present invention allow the user to perform a dynamic paging function on the data to be edited according to personal usage requirements, such as according to the user's paging gesture or the default “paging” mechanism of the electronic display device, in the process of operating the electronic display device for edition in the Notepad function. Accordingly, the operation of the user in the data editing operation (e.g. classifying data, copy/paste data, storing data and so on) can be more convenient and user-friendly.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for dividing pages, applicable to an electronic display device, comprising:
starting an edit page on a display screen;
receiving a paging operation to generate at least one page break in at least one position of the edit page; and
when the at least one page break is generated, dividing the edit page into at least two separate pages according to the at least one page break, wherein the separate pages are respectively saved as different files.

2. The method according to claim 1, wherein the step of dividing the edit page into the at least two separate pages according to the at least one page break comprises:
respectively generating a horizontal dividing line in the position of the at least one page break;
determining whether the at least one horizontal dividing line goes through any one of objects in the edit page; and
when the at least one horizontal dividing line does not go through any one of the objects in the edit page, dividing the edit page into the separate pages according to the at least one horizontal dividing line.

3. The method according to claim 2, wherein the step of dividing the edit page according to the at least one page break further comprises:
when the at least one horizontal dividing line goes through any one of the objects in the edit page, setting a predetermined horizontal range neighboring with one of the at least one horizontal dividing line and determining whether a horizontal line within the predetermined horizontal range goes through the objects in the edit page; and
when there is a specific horizontal line within the predetermined horizontal range not going through any one of the objects in the edit page, dividing the edit page into the separate pages according to the specific horizontal line.

4. The method according to claim 2, wherein the step of dividing the edit page according to the at least one page break further comprises:
when the at least one horizontal dividing line goes through any one of the objects in the edit page, setting a predetermined horizontal range neighboring with at least one of the horizontal dividing lines and determining whether a horizontal line within the predetermined horizontal range goes through any one of the objects in the edit page and generating a first diagonal using a starting node of the predetermined horizontal range and an angle, wherein the angle is within a predetermined angle range;
when the first diagonal already goes through any one of the objects in the edit page, keeping adjusting the angle in the predetermined angle range until the first diagonal does not go through any one of the objects in the edit page and reaches another end of the edit page; and
dividing the edit page into the at least two separate pages according to the first diagonal.

5. The method according to claim 4, wherein the step of dividing the edit page according to the at least one page break further comprises:
when the first diagonal with respect to the angle all goes through any one of the objects in the edit page, serving a node formed by mapping one of the objects that is the most horizontally closed to the starting node with a vertical boundary of the one of the objects that is the furthest from the starting node on the at least one horizontal dividing line as a terminal node, serving the terminal node as the starting node to determine whether at least one second diagonal is generated and making the at least one second diagonal not going through any one of the objects in the edit page; and
dividing the edit page into the separate pages according to the first diagonal and the at least one second diagonal.

6. The method according to claim 1, wherein the step of dividing the edit page according to the at least one page break comprises:
dividing the edit page into the at least two separate pages based on the at least one page break and along a connection line bypassing an upper or lower edge of at least one object in the edit page.

7. The method according to claim 1, wherein the step of receiving the paging operation comprises:
serving at least one paging gesture on the display screen and dividing the edit page into the at least two separate pages according to a position of the at least one paging gesture in the edit page, wherein the paging gesture comprises a dividing curved line, and the edit page is divided into the at least two separate pages according to the dividing curved line.

8. An electronic display device, comprising:
a display screen, configured to start an edit page on the display screen;
a processor, coupled to the display screen and configured to receive a paging operation to generate at least one page break in at least one position of the edit page and divide the edit page into at least two separate pages according to the at least one page break; and
a memory unit, coupled to the processor and configured to respectively save the separate pages as different files.

9. The electronic display device according to claim 8, wherein the processor in the step of dividing the edit page according to the at least one page break performs steps of:
generating a horizontal dividing line in the position of the at least one page break;
determining whether the at least one horizontal dividing line goes through any one of objects in the edit page; and
when the at least one horizontal dividing line does not go through any one of the objects in the edit page, dividing the edit page into the at least two separate pages according to the at least one horizontal dividing line.

10. The electronic display device according to claim 9, wherein the step of dividing the edit page according to the at least one page break further performs steps of:
when the at least one horizontal dividing line goes through any one of the objects in the edit page, setting a predetermined horizontal range neighboring with at least one horizontal dividing line and determining whether horizontal lines within the predetermined horizontal range go through any one of the objects in the edit page; and
when there is a specific horizontal line within predetermined horizontal range not going through any one of the objects in the edit page, dividing the edit page into the at least two separate pages according to the specific horizontal line.

11. The electronic display device according to claim 9, wherein the processor in the step of dividing the edit page according to the at least one page break further performs steps of:
when the at least one horizontal dividing line goes through any one of the objects in the edit page, setting a predetermined horizontal range neighboring with at least one of the horizontal dividing lines and generating a first diagonal using a starting node of the predetermined horizontal range and an angle, wherein the angle is within a predetermined angle range;
when the at least one horizontal dividing line goes through any one of the objects in the edit page, keeping adjusting the angle in the predetermined angle range until the first diagonal does not go through any one of the objects in the edit page and reaches another end of the edit page; and
dividing the edit page into the at least two separate pages according to the first diagonal.

12. The electronic display device according to claim 9, wherein in the step of dividing the edit page according to the at least one page break further performs steps of:
when all the first diagonals go through any one of the objects in the edit page, serving a node formed by mapping one of the objects that is the most horizontally closed to the starting node with a vertical boundary of the one of the objects that that is the furthest form the starting node on the at least one horizontal dividing line as a terminal node, serving the terminal node as the starting node to determine whether at least one second diagonal is generated and making the at least one second diagonal not going through any one of the objects in the edit page; and
dividing the edit page into the separate pages according to the first diagonal and the at least one second diagonal.

13. The electronic display device according to claim 8, wherein in the step of dividing the edit page according to the at least one page break further performs steps of:
dividing the edit page into the at least two separate pages based on the at least one page break and along a connection line bypassing an upper or lower edge of at least one object in the edit page.

14. The electronic display device according to claim 8, in the step of receiving the paging operation performs steps of:
serving at least one paging gesture on the display screen as the paging operation and dividing the edit page into the at least two separate pages according to a position with of the at least one paging gesture in the edit page, wherein the paging gesture comprises a dividing curved line, and the edit page is divided into the at least two separate pages according to the dividing curved line.
